(19) United States
(12) Patent Application Publication
(10) Pub. No.: US 2025/0229336 A1
(43) Pub. Date: Jul. 17, 2025

(54) SYSTEMS AND METHODS FOR CRACK GROWTH-BASED LIFE PREDICTION FOR ADDITIVELY MANUFACTURED METALLIC MATERIALS CONSIDERING SURFACE ROUGHNESS

(71) Applicant: Yongming Liu, Chandler, AZ (US)

(72) Inventor: Yongming Liu, Chandler, AZ (US)

(73) Assignee: Arizona Board of Regents on Behalf of Arizona State University, Tempe, AZ (US)

(21) Appl. No.: 19/012,727

(22) Filed: Jan. 7, 2025

Related U.S. Application Data
(60) Provisional application No. 63/621,431, filed on Jan. 16, 2024.

(51) Int. Cl. B22F 10/80; B33Y 50/00

(52) U.S. Cl. CPC B22F 10/80; B33Y 50/00

(57) ABSTRACT

A time-based prediction model that models surface roughness of an additively manufactured (AM) component as a single equivalent notch with a crack at the notch root in which the notch reflects the stress concentration due to an entire spectrum of surface roughness of the AM component is disclosed herein.

### CROSS REFERENCE TO RELATED APPLICATIONS

This is a non-provisional application that claims benefit to U.S. Provisional Application Ser. No. 63/621,431 filed on Jan. 16, 2024, which is herein incorporated by reference in its entirety.

### FIELD

The present disclosure generally relates to systems and methods for predicting fatigue life of additively manufactured metallic objects under various loading conditions.

### BACKGROUND

In a homogeneous material, cracks usually initiate at the surface, making the surface condition an influencing factor in fatigue life assessment. While residual stress, microstructure, and surface roughness have been identified to be the most important parameters while dealing with surface conditions there is no universally accepted method to correlate surface roughness with fatigue life.

Additive manufacturing (AM) has been extensively studied in recent years as an alternate manufacturing process by which parts with complex geometries can be easily produced by depositing the material in a layer-by-layer fashion as opposed to conventional methods that are usually characterized by material removal processes. One of the interesting structures that can be produced by AM are thin-walled metal structures, including honeycombs. Additive manufacturing enabled the reinvention of the honeycomb structure, and they are widely used in various engineering applications today. These structures can absorb or dissipate the initial kinetic energy from external loads in a controlled manner. As a result, the applications of these structures usually involve loading scenarios featuring compressive or impact loads. The automotive and aerospace industries adopt these structures due to their high stiffness to weight ratio under compression. Exploring the capabilities offered by AM in optimizing the mechanical performance of these structures is an important research topic today. Under in-plane loadings, the cell walls of these structures bend due to lower compressive strength. The in-plane performance of honeycombs can be controlled by varying their geometric features, including the cell wall thickness. Baranowski et al. investigated the effect of cell size on the compressive performance of Ti-6A1-4V honeycombs and found that the 3 mm cells outperformed their 5 mm counterparts. This could be attributed to their higher geometrical stiffness relative to those with larger cell sizes. Additively manufactured honeycomb structures have several potential issues such as nonuniform energy absorption capacity due to poor geometrical properties and surface qualities as compared to conventionally manufactured ones. There is ongoing research on the design of honeycomb cores, and recently bioinspired designs are being investigated.

Researchers have found that the hardness and tensile strength of AM materials are close to those of conventional materials. However, it is widely observed that the fatigue properties differ considerably due to a variety of reasons, with surface roughness and porosity being the major detrimental factors. For one to neglect surface roughness (SR), the upper limit for average roughness (Rₐ) as recommended by ASTM is 0.2, but the AM fabricated parts usually tend to have a higher Rₐ. There are numerous challenges to be solved before AM can be employed in industries such as aerospace, with understanding the fatigue behavior being one of them. In view of the high qualification and certification standards of such industries, there is a greater need for reliable prediction on the mechanical performance of AM parts under cyclic loads.

Nomenclature

| | |
|---|---|
| a | Crack length |
| a₀ | Initial crack length |
| a_{c} | Critical crack length |
| A, B | Subcycle model parameters |
| C, m | Paris constants |
| d | Notch depth |
| $\frac{da}{dN} or \frac{da}{dt}$ | Crack growth rate |
| E | Young's modulus |
| f − i | Normal fatigue limit |
| J₁, J₂ | Fitting parameters for surface finish factor |
| K | Stress intensity factor |
| K_{I}, K_{II}, K_{III} | Mode I, mode II, and mode III stress intensity factors |
| Kₜₕ | Threshold stress intensity factor |
| K_{C} | Critical stress intensity factor or fracture toughness |
| K_{I,th}, K_{II,th} | Mode I and mode II threshold stress intensity factors |
| k₁, k₂, k^{H} | Loading related parameters |
| Kₘᵢₙ,Kₘₐₓ | Minimum and maximum stress intensity factors |
| K_{max,mem} | Memory variable for maximum stress intensity factor |
| Kₜ | Stress concentration factor |
| L | Assessment length |
| N_{f} | Cycles to failure |
| 2N_{f} | Reversals to failure |
| n | Stress state |
| P, Q | Multiaxial model parameters |
| R | Stress ratio |
| Rₐ | Average roughness |
| R_{y} | Maximum peak to valley height roughness |
| R_{z} | 10-point height roughness |
| Rᵥ | Maximum valley depth |
| Rₜ | Maximum height of profile |
| s | Parameter related to material ductility |
| Sᵤₜ | Ultimate tensile strength |
| t | Time |
| t₋₁ | Shear fatigue limit |
| Y | Geometric correction factor |
| z | Profile height distribution |
| α | Critical plane orientation |
| β | Maximum normal stress amplitude plane orientation |
| γ | Angle between fracture plane and critical plane |
| Δα | Crack increment |
| Δτ | Time increment |
| Δσ | Stress range |
| δ | Crack tip opening displacement |
| δₘᵢₙ, δₘₐₓ | Minimum and maximum crack tip opening displacement |
| λ | Ratio between height and spacing of surface |
| | irregularities |
| ρ, ρ̅ | Notch root radius and effective notch root radius |
| σ_{y}, σᵤ | Yield strength and ultimate tensile strength |
| σ_{c} | Normal stress amplitude |
| σ^{H} | Hydrostatic stress amplitude |
| σ_{w} or σ_{f} | Fatigue limit |
| φ | Finite dimension correction factor |
| τ_{c} | Shear stress amplitude |

Hot Isostatic Pressing (HIP) was initially explored to eliminate surface roughness of AM fabricated parts. The combined effect of a rough as-built surface and a geometrical notch for additively manufactured Ti64 fabricated by laser sintering and electron beam melting has been previously studied. It was also found that HIP did not have an impact on fatigue life. Additional research has stated that HIP is not helpful because HIP only reduces internal defects such as process-induced voids, but SR is more dominant than internal defects. Also, previous research has found that the fatigue limits of as-built specimens with HIP were only about 30% of the ideal fatigue limit. No difference was noticed in the surface texture of as-built specimens with and without HIP treatment. On the other hand, surface polishing treatments were found to improve the fatigue life. Another study noticed an increase in fatigue limit by 300 MPa for an additively manufactured Ti-6A1-4V after reducing the average roughness from 13 to 0.5 gm. Although one could argue that machining the rough surfaces can solve the problem, it is not always feasible. For instance, a part with complex geometry can have certain sections that are inaccessible for polishing. Also, it is not a cost-effective option during mass production. As surface roughness is unavoidable, especially for as-built AM parts, it is of paramount importance to understand and quantify the interplay between inherent roughness and fatigue behavior of AM materials.

Some studies have reported the sources for surface roughness in AM parts such as partially melted powder particles attached to the surface, premature solidification of melt pool, and unfilled cavities between layers. Fatigue properties of unnotched specimens with rough as-built surfaces have been widely studied in the past. The peaks on the surface do not affect the fatigue behavior, however, the valleys on the surface act as micro-notches promoting early life crack initiation. A previous study highlighted that predicting the variations in mechanical behavior (especially fatigue) of AM parts is necessary because laboratory sample sizes and real-life application parts will be different leading to different properties while manufacturing.

Before studying the detrimental effects of surface roughness, it is necessary to extract the rough surface profiles from the test specimens and quantify them. Obtaining surface morphology is commonly done by contact profilometry, where a stylus slides over the surface and records the position. However, the accuracy of this method largely depends on the radius of the stylus. For larger tip radius, it is difficult to capture deep valleys. For smaller tip radius, a sharp tip could scratch the part surface, which further deteriorates the surface quality. Errors due to finite radius of stylus tips are unavoidable and to overcome this issue, non-contact methods have been incorporated in a few studies. Different parameters such as average roughness (Rₐ) and maximum valley depth (Rᵥ) are commonly used to represent surface texture. A previous study proposed maximum profile height as the initial crack length for additively manufactured Ti-6A1-4V. Another study considered the valley depth to represent initial crack length. It has also been suggested that the maximum height of profile (Rₜ) and 10-point height (R_{z}) parameters are better than Rₐ because they represent the worst defects on the surface. Yet another previous study used the maximum peak to valley height parameter (R_{y}) as the crack depth where the roughness notches were assumed to be periodic cracks.

The effect of surface roughness on fatigue life is particularly significant in the high cycle fatigue (HCF) region that is governed by lower stresses. The reason behind a greater effect in HCF region is that the low stress levels do not lead to large plastic deformation at the tips of the rough surface valleys and cause an accelerated crack growth as compared to the low cycle fatigue (LCF) region. The effects of surface conditions on the fatigue strength were conventionally taken into account by introducing surface finish factors:

$${K}_{a} = {J}_{1} {S}_{ut}^{{J}_{2}} \qquad ( 1 )$$

where Sᵤₜ is the ultimate tensile strength of the material, and ‘J₁’ and ‘J₂’ are fitting parameters dependent on the type of surface condition. However, such factors are overly conservative and the stochasticity in surface roughness leads to large scatter in fatigue data. Modifications for the same have been proposed in several studies. Beyond the empirical equations, few researchers proposed various analytical expressions to capture the effects of surface roughness. Some of the research developed a formulation based on roughness parameters to estimate the effective stress concentration factor due to the rough surfaces. It has been previously proposed to use finite element simulations to calculate stress concentration factor, Kₜ modeled surface roughness as defects and an expression for the effective area of the periodic defects was developed, which along with the material hardness is used to estimate the fatigue limit (σ_{w}).

$${σ}_{w} = \frac{1.43 ( HV + 120 )}{{( \sqrt{{area}_{eff}} )}^{\frac{1}{6}}} \qquad ( 2 )$$

In addition, several experimental studies were carried out in the last few years. Two previous studies tested additively manufactured Ti-6A1-4V specimens and observed a reduction in the fatigue strength as compared to the wrought material. The studies also noticed that machining did not improve the fatigue performance as the internal defects reached the surface after the machining process. Other research has studied the fatigue behavior of additively manufactured 304L stainless steel specimens fabricated by laser beam powder bed fusion (LB-PBF) method. The study considered two surface conditions, as-built (AB) and machined and polished (M/P) and found that the crack initiation was dominated by surface features in the AB specimens, while defects near the surface dominated in case of M/P specimens. Similar to what is reported in the literature, it was also observed that surface roughness had little impact in the low cycle fatigue regime. A few studies were also carried out to investigate the crack propagation mechanisms in AM parts. One study investigated Ti-6A1-4V fabricated by wire arc additive manufacturing (WAAM) method, and another studied a stainless-steel part produced by the same method. While the literature on experimental studies and fatigue modeling under constant and variable amplitude loading conditions is extensive, there are relatively very few models that can handle uniaxial and multiaxial, constant and random loading spectrums and predict fatigue life by considering the surface roughness of components.

It is with these observations in mind, among others, that various aspects of the present disclosure were conceived and developed.

### BRIEF DESCRIPTION OF THE DRAWINGS

FIG. 1 is a graphical representation of standard roughness parameters.

FIG. 2 is a schematic illustration of the disclosed configuration for roughness modeling.

FIG. 3 is a graphical representation of short and long crack growth phenomena.

FIG. 4 is a graphical representation of a KT diagram illustrating bilinear curves.

FIG. 5 is a graphical representation of phases in fatigue crack growth.

FIG. 6A is a graphical representation of the loading spectrum for constant amplitude.

FIG. 6B is a graphical representation of the loading spectrum for periodic overloads and underloads.

FIG. 6C is a graphical representation of the loading spectrum for random loading.

FIG. 7 is a graphical illustration of crack increment versus crack tip opening displacement (CTOD) variation.

FIG. 8A is a schematic illustration of variable amplitude loading path in variable loading spectrum.

FIG. 8B is a schematic illustration of CTOD variation for the variable amplitude loading path.

FIG. 9 is a flowchart of fatigue crack growth calculation.

FIG. 10 is a schematic representation of critical plane angle.

FIG. 11 is an illustration of surface roughness measurement using the micro-CT model.

FIG. 12 is a schematic illustration of a process map for fabricating Ti64 specimens.

FIG. 13 is side view illustration of the final crack shapes.

FIG. 14 is a schematic illustration of the fractography of sample G5v.

FIG. 15 is a schematic illustration of the fractography of sample Y6a.

FIG. 16 is a plot of S-N curves for in-house Ti-6Al-4V data.

FIG. 17 is a plot of error for in-house data validation.

FIG. 18 is a plot of S-N curves for data from Pegues et al.

FIG. 19 is a plot of error for data from Pegues et al.

FIG. 20 is a plot of S-N curves for 304L stainless steel data.

FIG. 21 is a plot of error for 304L stainless steel data.

FIG. 22 is a plot of S-N curves for Ti-6Al-4V data from Fatemi et al.

FIG. 23 is a plot of error for data from Fatemi et al.

FIG. 24 is a plot of S-N curves for data from Fatemi et al.

FIG. 25 is a plot of error for data from Fatemi et al.

FIG. 26 is a plot of S-N curves for data from Renzo et al.

FIG. 27 is a plot of error for data from Renzo et al.

FIG. 28 is an exemplary computer system for effectuating the functionalities of fatigue life assessment of an AM component.

Corresponding reference characters indicate corresponding elements among the view of the drawings. The headings used in the figures do not limit the scope of the claims.

### DETAILED DESCRIPTION

The present disclosure relates to a crack growth-based methodology for the fatigue life assessment of AM components subjected to uniaxial and multiaxial, constant and variable loading conditions. The disclosed method is based on a previously developed subcycle fatigue crack growth (FCG) model. The previously developed FCG model is extended with the stress concentration factor due to surface roughness and an asymptotic stress intensity factor (SIF) interpolation method for notched specimens. The disclosed method approximates the surface roughness as an equivalent notch having the same stress concentration as that posed by the irregularities on the surface. Fatigue life assessment is performed based on the concept of equivalent initial flaw size (EIFS) and FCG analysis. The disclosed methodology was validated against in-house as well as experimental data from the available literature.

To achieve this goal, it is important to understand and solve different challenges.

### 1. Introduction

Motivated by the need to have a reliable fatigue model considering surface roughness, a method of predicting the life of AM parts with a life prediction model to quantify the fatigue performance of AM parts having rough surfaces subjected to uniaxial and multiaxial constant as well as random loading conditions has been developed. With the assumption of an existing crack in the material, incorporating crack growth-based models will be well justified for the estimation of fatigue life. The present disclosure focuses on a time-based fatigue life prediction model considering surface roughness of both conventional as well as additively manufactured parts. The present disclosure first presents a brief review on the importance of surface quality and how additively manufactured parts are at risk of reduced fatigue performance due to their surface texture. Following this, the methodology of the proposed model and method is disclosed, in addition to the model validation under uniaxial and multiaxial loading conditions. Finally, several concluding remarks are made and the scope for future work is presented.

### 2. Model Description

### 2.1 Modeling of Surface Roughness

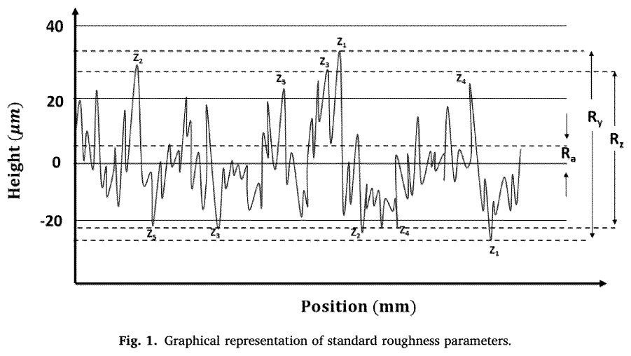

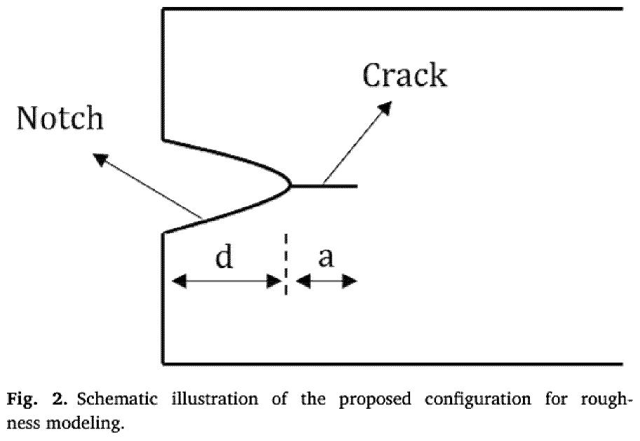

Surface roughness can be described as a series of peaks and valleys on the surface of a component, where the valleys usually act as micro notches and contribute to early crack initiation. As mentioned previously, several parameters were defined to characterize surface roughness and the average roughness is widely considered to be a good indicator. A graphical representation of the roughness parameters used to define surface texture is shown in FIG. 1. Unlike other studies where the surface roughness, where Kₜ is the effective stress concentration induced by the surface roughness, was modeled as series of cracks or an elliptical surface micro-notch, the present disclosure models the surface roughness as a single equivalent notch with a crack at the notch root as depicted by FIG. 2. In this configuration, the notch reflects the stress concentration due to the entire spectrum of surface roughness and this quantity can be estimated by various expressions proposed by several researchers based on standard roughness parameters given by the Eqs. (3), (4), and (5). Here ‘z’ is the profile height distribution over an assessment length ‘L’

$${R}_{a} = \frac{1}{L} {\int }_{0}^{L} \vert z \vert dx \qquad ( 3 )$$

$${R}_{y} = \vert {Z}_{max} - {Z}_{min} \vert \qquad ( 4 )$$

$${R}_{z} = \frac{1}{5} [ {\sum }_{i = 1}^{5} {( {Z}_{i} )}_{max} + {\sum }_{j = 1}^{5} {( {Z}_{j} )}_{min} ] \qquad ( 5 )$$

A previous study proposed the formula given by Eq. (6). Although this could capture the roughness, it fails to capture the waviness usually accompanied with the surface irregularities. To capture roughness as well as waviness, further studies proposed a modified expression given by Eq. (7).

$${K}_{t} = 1 + n \sqrt{λ \frac{{R}_{z}}{ρ}} \qquad ( 6 )$$

$${K}_{t} = 1 + n ( \frac{{R}_{a}}{\overline{ρ}} ) ( \frac{{R}_{y}}{{R}_{z}} ) \qquad ( 7 )$$

where Kₜ is the effective stress concentration induced by the surface roughness, Rₐ, R_{y} and R_{z} represent the average roughness, maximum peak-to-valley height roughness and 10-point roughness parameters, respectively. ‘p′’ is the notch root radius and ‘p̅’ the effective notch root radius obtained by averaging the radius from dominant profile valleys (Eq. (8)). ‘n’ represents the stress state, taking a value of 1 for shear loads and 2 for tensile loads. This expression was initially employed for composite materials and later used for additively manufactured parts.

$$\overline{p} = \frac{1}{5} [ {\sum }_{j = 1}^{5} {ρ}_{j} ] \qquad ( 8 )$$

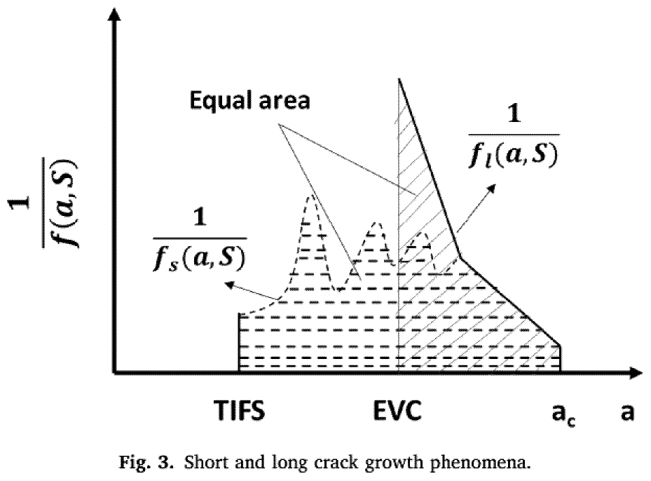

Using Eq. (7), the effective stress concentration for the representative notch will be calculated in the present disclosure. For any fatigue model premised upon the fracture mechanics approach, a solution for the stress intensity factor (SIF) is required. The method for modeling surface roughness in the present disclosure requires a SIF solution for an edge-notched specimen with a crack at the notch tip and is taken from a methodology proposed by previous researchers. The expression for SIF can be expressed as:

$$K = {1.122}_{φσ} \sqrt{π ( a + d \{ 1 - exp [ - \frac{a}{d} ( \frac{{K}_{t}^{2}}{{φ}^{2}} - 1 ) ] \} )} \qquad ( 9 )$$

where φ is a finite dimension correction factor whose formulas can be found in several handbooks for the stress analysis of cracks, ‘a’ is the crack length, ‘d’ is the notch depth and ‘Kₜ’ is the stress concentration factor, which in the case of the present disclosure is the effective stress concentration factor estimated from the Eq. (7). It should be noted that the average roughness (Rₐ) is chosen as the depth of the notch (d) in the disclosed model. Although a few studies considered the maximum valley depth (Rᵥ) as the representative parameter for surface roughness on the basis that it geometrically represents the worst stress concentration zone where cracks usually initiate, the present disclosure does not focus on the crack initiation location, but rather focuses on the mean fatigue life prediction (e.g., S-N curves). It was found that the disclosed model predictions using average roughness as the notch depth correlate well with experimental fatigue life data (in the mean sense). Hence, it was suggested to incorporate Rₐ as the notch depth in the method's fatigue life prediction framework. As mentioned earlier, any material will have certain internal defects and the assumption of an existing crack holds true. With this assumption, incorporating crack growth-based models for fatigue life estimation will be well justified and they require a value for the initial crack size. Should the size of true initial flaw in a material be considered, usually in the order of microns or less, it violates several assumptions of linear elastic fracture mechanics (LEFM) and long crack growth models such as the Paris' law cannot be used. A concept called Equivalent Initial Flaw Size (EIFS) was proposed by a prior study to bypass the short crack growth theory. Although it is not the true initial flaw size (TIFS) but just a model calibration parameter approximated from experimental observations, it enables fracture mechanics-based fatigue life predictions that are in good agreement with experimental data for similar specimens. This mechanism can be illustrated by a schematic as shown in FIG. 3. Considering short and long crack growth theories along with a simple crack growth model as Eq. (10).

$$\frac{da}{dN} = f ( a , S ) \qquad ( 10 )$$

where ƒ is a function of crack length and applied stress. If the short crack growth theory is considered i.e., TIFS, the fatigue life can be estimated using Eq. (11), where a_{N}, is the crack size after N cycles.

$$N = \int dN = {\int }_{TIFS}^{{a}_{N}} \frac{1}{{f}_{s} ( a , S )} da \qquad ( 11 )$$

Instead, if the long crack growth theory is considered i.e., equivalent virtual crack (EVC), the fatigue life can be estimated using Eq. (12).

$$N = \int dN = {\int }_{EVC}^{{a}_{N}} \frac{1}{{f}_{l} ( a , S )} da \qquad ( 12 )$$

Eqs. (11) and (12) are graphically shown in FIG. 3.

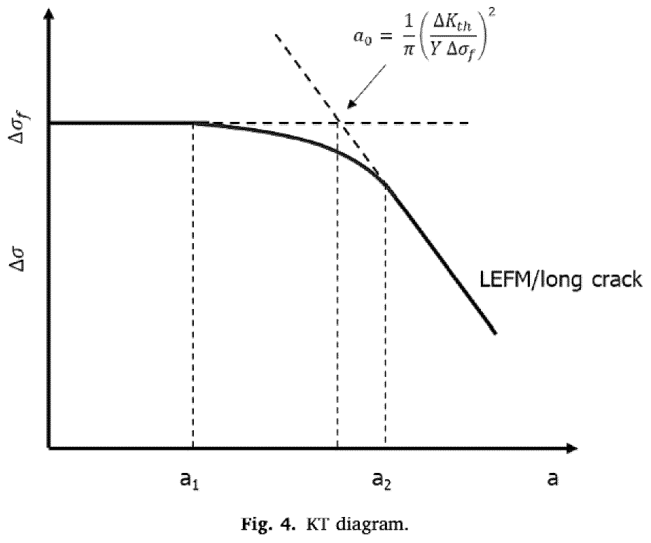

According to the Kitagawa-Takahashi (KT) diagram, the endurance or fatigue limit of a cracked component decreases as the crack size increases. Below a certain threshold crack length, the fatigue limit remains constant. The KT diagram is shown in FIG. 4, with both the bilinear curves just mentioned. A deviation from this behavior was identified by a prior study where a certain crack length a₁ can reduce the fatigue limit considerably and by reaching another crack length a₂, the effect of small crack behavior diminishes and the curve approaches LEFM/long crack behavior.

A prior study also proposed a model to capture this asymptotic behavior with a single equation in which a length constant (a₀) is added to the actual crack length to describe the short crack behavior. This is given by Eq. (13).

$$Δσ = \frac{Δ {K}_{th}}{Y \sqrt{π ( a + {a}_{0} )}} \qquad ( 13 )$$

For small cracks, the threshold stress range approaches the fatigue limit of material (from smooth specimen testing):

$${lim}_{a \to 0} Δσ = {Δσ}_{f} = \frac{Δ {K}_{th}}{Y \sqrt{π {a}_{0}}} \qquad ( 14 )$$

Rearranging Eq. (14) gives the critical crack length i.e., the minimum value for EIFS from which LEFM becomes applicable. This critical length is usually considered to be the boundary between short and long crack behavior.

$${a}_{0} = \frac{1}{π} {( \frac{Δ {K}_{th}}{Y Δ {σ}_{f}} )}^{2} \qquad ( 15 )$$

where ‘Y’ is a geometric correction factor that can be obtained from various handbooks and literature.

Using Eq. (15) the size of the equivalent initial flaw can be calculated and thereby fatigue life predictions can be carried out. However, there is a difficulty in obtaining the appropriate threshold stress intensity factor value. This is due to the difference in the measurement techniques between short and long crack specimens. By using long crack specimens following ASTM standards, one will end up getting shorter fatigue lives and the opposite in case of short cracks. This results in larger error in the near-threshold region and comparatively small error in the Paris regime. This highlights the need for an accurate value of ΔKₜₕ independent of the pre-existing crack and a method to obtain it. It has been noted by previous studies that the long crack growth data from the Paris region can be used to estimate the ΔKₜₕ. This is done by extrapolating the long crack growth curve from the Paris region to a crack growth rate corresponding to 10^{-10°} m/cycle in the da/dN vsΔK plot and taking the respective stress intensity factor value as the necessary ΔKₜₕ. Based on this, the value of EIFS can be calculated from Eq. (15).

### 2.2 Time-Based Fatigue Crack Growth

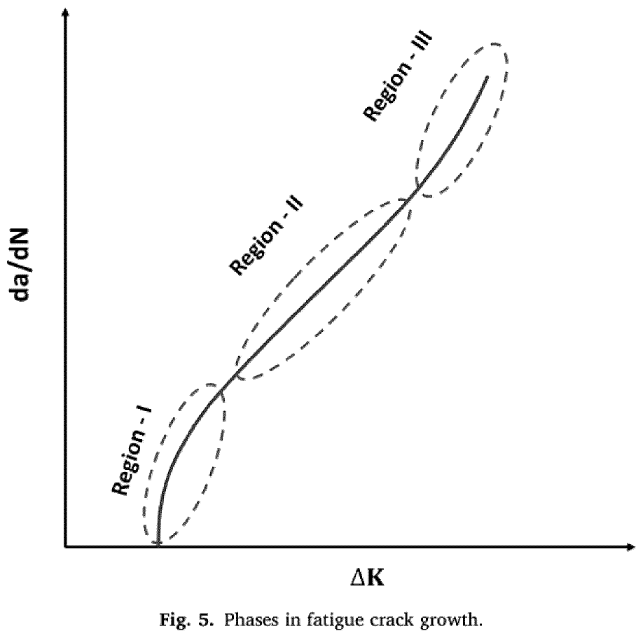

Quantitative estimation of fatigue life is very interesting and useful. Under cyclic loading, a fatigue crack goes through three phases: crack initiation, crack propagation and final fracture. These are shown in FIG. 5 as region-I, region-II, and region-III, respectively. In general, fatigue life is dominated by the first two phases. The presence of surface roughness eases the initiation of cracks and leads to much of the life being spent in the crack propagation phase.

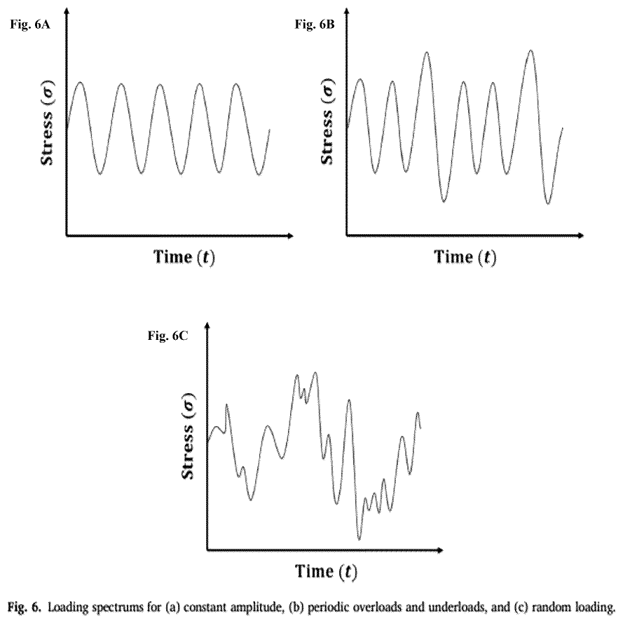

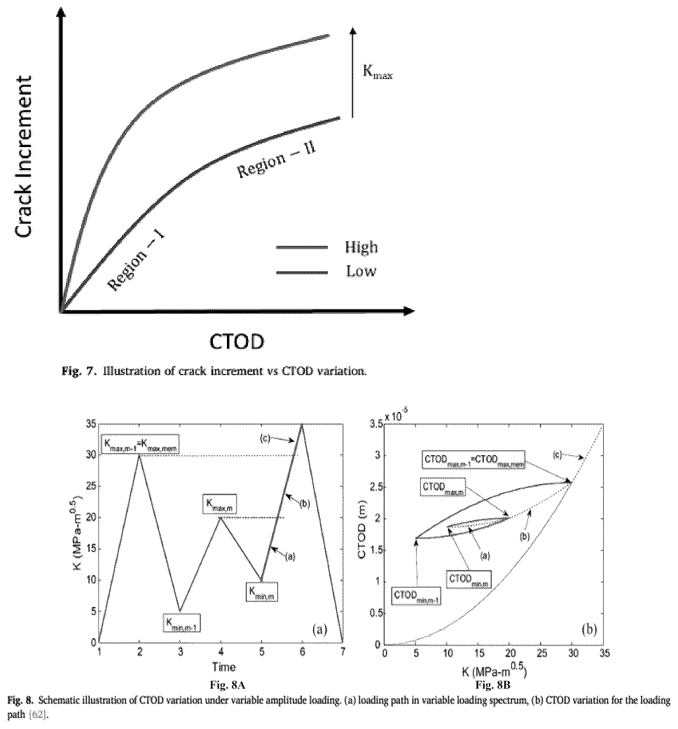

In the past, numerous studies were conducted for fatigue crack growth (FCG) analysis under constant as well as variable amplitude loading conditions. A major drawback with the existing cycle-based algorithms is that they fail to capture the crack growth at any instantaneous point in the loading spectrum, and instead estimate the updated crack growth at the end of a particular cycle. This problem is particularly concerning in the case of real-world loading spectrums that are usually much more complex than what were considered in the studies dealing with variable loadings with periodic overloads and underloads. FIGS. 6A and 6B show the loading spectrums for constant amplitude and periodic overloads and underloads. These loading conditions can be dealt with cycle-based fatigue models as the cycle peaks are clearly defined. However, the same is not true in the case of a random loading spectrum shown in FIG. 6C. For such scenarios, calculating the crack where Δa is the increment in crack growth with time Δt.

The present disclosure incorporates a time-based subcycle fatigue crack growth model that is based on incremental crack growth (da/dt) and can be used at various time and length scales as opposed to cycle-based models (da/dN). The incremental crack length can be obtained by integrating over time ‘t’ as follows:

$$Δ a = {\int }_{t}^{t + Δ t} \frac{da}{dt} ( a , E , σ , {σ}_{y} , … ) dt \qquad ( 16 )$$

where Δa is the increment in crack length over time Δt.

The crack growth kinetics function relates the crack increment (Δa) with the incremental crack tip opening displacement (dδ). A prior study performed in-situ SEM testing and observed a nonlinear relation between crack growth and crack tip opening displacement (CTOD), and that the crack growth depends on maximum stress intensity factor (Kₘₐₓ). It was observed that crack growth occurs only when the CTOD, denoted by ‘δ’, starts from zero as shown in FIG. 7. Also, accelerated crack growth (region-1) was observed as the crack starts to open and slowly subsides (region-2) due to crack tip blunting caused by plastic deformation.

Additionally, the maximum stress intensity factor (Kₘₐₓ) was found to influence the crack growth by the mechanism of micro-cracking ahead of the crack tip. By operating at higher (Kₘₐₓ), the crack increment was found to be faster/higher for the same CTOD variation when compared to operating at lower (Kₘₐₓ). This behavior was explained by the fact that a higher (Kₘₐₓ) leads to an increased number of small cracks/voids ahead of the crack tip, causing a reduction in the crack growth resistance of the material. This is illustrated by the shift from blue curve (behavior while operating at lower (Kₘₐₓ)) to the red curve (behavior while operating at higher (Kₘₐₓ)) in FIG. 7.

Based on these observations, the following expression was developed (Eq. (17)) for crack increment calculation:

$$a = A \times {K}_{max}^{B} \times {δ}^{0.5} \qquad ( 17 )$$

Upon differentiating Eq. (17) with respect to time, the sub-cycle crack growth rate function is defined by Eq. (18)

$$\frac{da}{dt} = \frac{A \times {K}_{max}^{B}}{2 \sqrt{δ}} \frac{d δ}{dt} \qquad ( 18 )$$

where (Kₘₐₓ) is the maximum stress intensity factor from the previous loading history, and the parameters ‘A’ and ‘B’ can be obtained from cycle-based fatigue crack growth testing results under fully reversed loading conditions as Eqs. (19) and (20).

$$A = \frac{C \times {2}^{B} \times \sqrt{2 E {σ}_{y}}}{0.6} \qquad ( 19 )$$

$$B = m - 1 \qquad ( 20 )$$

where C and m are the well-known Paris constants, E is the Young's modulus, and σ_{y} is the material yield strength.

After figuring out the crack growth kinetics function and its parameters (A, B and Kₘₐₓ), a solution for the calculation of CTOD at any arbitrary point in the loading spectrum is still needed. The CTOD calculation process is highly nonlinear and requires numerical tools. A simple analytical approximation based on a modified Dugdale model was previously proposed to calculate the CTOD and is used herein. The mathematical equations required for the calculations are presented here in Eqs. (21) and (22):

$${δ}_{loading} = \{ \begin{matrix}\frac{{K}^{2}}{E {σ}_{y}} > K > {K}_{max , mem} \\ {δ}_{min , m - 1} + \frac{{( K - {K}_{min , m - 1} )}^{2}}{2 E {σ}_{y}} {K}_{max , mem} \geq K \geq {K}_{max , m - a} \\ {δ}_{min , m} + \frac{{( K - {K}_{min , m} )}^{2}}{2 E {σ}_{y}} {K}_{max , m - 1} \geq K\end{matrix} \qquad ( 21 )$$

$${δ}_{unloading} = \{ \begin{matrix}{δ}_{max , m - 1} + \frac{{( {K}_{max , m - 1} - K )}^{2}}{2 E {σ}_{y}} K \leq {K}_{min , m - 1} \\ {δ}_{max , m - 1} - \frac{{( {K}_{max , m - 1} - K )}^{2}}{2 E {σ}_{y}} K \geq {K}_{min , m - 1}\end{matrix} \qquad ( 22 )$$

where K_{max,m} and K_{min,m} correspond to the stress intensity factors for various local maxima and minima points in a random loading spectrum and ‘m’ is the location index of the pair of local peak and valley as depicted in FIG. 8. The corresponding CTOD values at these ‘m’ locations are represented by δ_{max,m} and δ_{min,m}, respectively. The term ‘K_{max,mem}’ Eq. (21) is just a memory variable that stores and tracks the maximum stress intensity factor value in the entire loading history.

TABLE 1
Material parameters for fatigue limit criterion.

| Material Property | $s = \frac{{t}_{- 1}}{{f}_{- 1}} \leq 1$ | | $s = \frac{{t}_{- 1}}{{f}_{- 1}} > 1$ |
|---|---|---|---|
| γ | $cos ( 2 γ ) = \frac{- 2 + \sqrt{4 - 4 ( \frac{1}{{s}^{2}} - 3 ) ( 5 - \frac{1}{{s}^{2}} - 4 {s}^{2} )}}{2 ( 5 - \frac{1}{{s}^{2}} - 4 {s}^{2} )} \leq 1$ | | γ − 0 |
| P | 0 | | 9(s² − 1) |
| Q | | ${[ {cos}^{2} ( 2 y ) {s}^{2} + {sin}^{2} ( 2 y ) ]}^{\frac{1}{2}}$ | s |

As most of the fatigue crack growth process is spent in the near-threshold region, it is necessary for any reliable model to capture the crack growth behavior in this region. This is achieved in the subcycle model by introducing an additional term to the crack growth rate function as shown in Eq. (23).

$$\frac{da}{df} = \frac{A \times {( {K}_{max} - {K}_{th} )}^{B}}{2 \sqrt{δ}} \frac{d δ}{dt} = \qquad ( 23 )$$

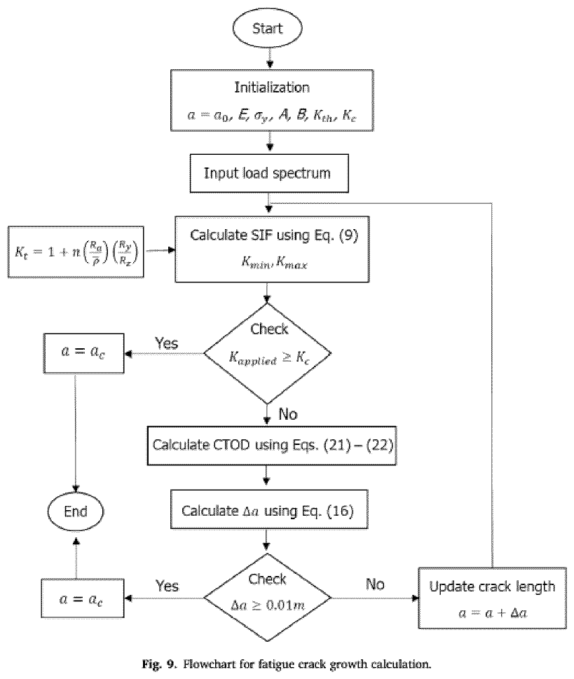

Every fatigue model requires a failure criterion to determine if a specimen has failed and what its final fatigue life is. In the current model, reaching a stress intensity factor value beyond the fracture toughness of the material or exceeding 0.01 m of crack increment in a single cycle is considered as failure as depicted in FIG. 9.

### 2.3 Extension to Multiaxial Loading

Uniaxial loadings are easy to handle during fatigue analysis. However, most real-life applications involve multiaxial loading conditions. Also, even if a component is subjected to uniaxial loads, several factors such as complex geometry, defects and interaction of residual stresses change the stress state from uniaxial to multiaxial. This can usually be seen in additively manufactured parts with rough surfaces. The subcycle model discussed previously is capable of handling uniaxial loads. But to successfully implement it for the fatigue life prediction of components considering their surface roughness, it is necessary to translate the multiaxial stresses into a single uniaxial stress that can be fed as an input to the model. Prior research proposed a methodology based on critical plane approach as shown in Eq. (24):

$$\sqrt{{( \frac{{σ}_{c}}{{f}_{- 1}} )}^{2} + {( \frac{{τ}_{c}}{{t}_{- 1}} )}^{2} + P {( \frac{{σ}^{H}}{{f}_{- 1}} )}^{2}} = Q \qquad ( 24 )$$

where σ_{c}, τ_{c}, and σ^{H}, are the normal, shear and hydrostatic stress amplitudes acting on the critical plane, respectively. ƒ₋₁ and t₋₁, Lᵢ are the normal and shear fatigue limits, respectively, and P, Q are material parameters which can be determined by uniaxial and torsional fatigue limits. The contribution of hydrostatic stress to the final failure of mechanical components under multiaxial fatigue loading varies with material properties, and the coefficient ‘P’ accounts for this.

A fatigue fracture plane refers to the crack plane observed at the macro level and critical plane is just a material plane on which fatigue damage is evaluated. The two planes may or may not coincide with each other. There are various definitions of the fatigue fracture plane in the literature. For example, one study defines it as the plane experiencing maximum principal stress and other studies suggest that it coincides with the weighted mean principal stress direction. In yet another study the model assumes the fatigue fracture plane to be the one experiencing maximum normal stress amplitude. The angle between the fracture plane and critical plane is ‘y’, which depends on the material. According to El Haddad model given by Eq. (13), the fatigue limit can be expressed using a fictional crack length ‘a’ and the threshold stress intensity factor i.e.,

$${f}_{- 1} = \frac{{K}_{I , th}}{\sqrt{π a}} \qquad ( 25 )$$

where K_{I,th} is the threshold stress intensity factor for mode I loading. A similar formula for mode II (or III) loading can be expressed as:

$${t}_{- 1} = \frac{{K}_{II , th}}{\sqrt{π a}} or ( {t}_{- 1} = \frac{{K}_{III , th}}{\sqrt{π a}} ) \qquad ( 26 )$$

where K_{II,th} and K_{III,th} are the threshold stress intensity factors for mode II and mode III loading, respectively.

As mentioned previously, the KT diagram links the fatigue behavior of cracked and uncracked material, and this can be used to extend the multiaxial fatigue limit criterion given by Eq. (24) to a mixed-mode threshold stress intensity factor criterion. Consider an infinite plate with a center crack subjected to remote tensile and shear stresses. The subjected loading leads to a mixed-mode I and II condition near the crack tip. Assuming zero stress ratio for both tensile and shear stresses, the mode I and mode II stress intensity factors for a crack in an infinite space can be expressed as Eqs. (27) and (28):

$${K}_{I} = σ \sqrt{π a} \qquad ( 27 )$$

$${K}_{II} = τ \sqrt{π a} \qquad ( 28 )$$

By substituting Eqs. (25)-(28) into Eq. (24), Eq. 29 is obtained:

$$\sqrt{{( \frac{{k}_{1}}{{K}_{I , th}} )}^{2} + {( \frac{{k}_{2}}{{K}_{II , th}} )}^{2} + P {( \frac{{k}^{H}}{{K}_{I , th}} )}^{2}} = Q \qquad ( 29 )$$

where k₁, k₂ and k^{H} loading-related parameters having the same units as stress intensity factor. For proportional loadings, they can be expressed as Eqs. (30)-(32):

$${k}_{1} = \frac{{K}_{I}}{2} ( 1 + cos ( 2 α ) ) + {K}_{u} sin ( 2 α ) \qquad ( 30 )$$

$${k}_{2} = - \frac{{K}_{I}}{2} sin ( 2 α ) + {K}_{u} cos ( 2 α ) \qquad ( 31 )$$

$${k}^{H} = \frac{{K}_{I}}{3} \qquad ( 32 )$$

‘α’ in the above expressions is the critical plane angle and it is the sum of the angle of plane of maximum normal stress amplitude (β) at the far field and the material parameter (γ) mentioned above.

TABLE 2
Building process parameters for Ti—6A1—4V.

| Hatch Spacing (mm) | Laser Scan Speed (mm/s) | Laser Power (W) |
|---|---|---|
| 0.14 | 1200 | 280 |

$$α = β + γ \qquad ( 33 )$$

For proportional loading,

$$β = \frac{1}{2} {tan}^{- 1} ( \frac{2 {K}_{II}}{{K}_{I}} ) .$$

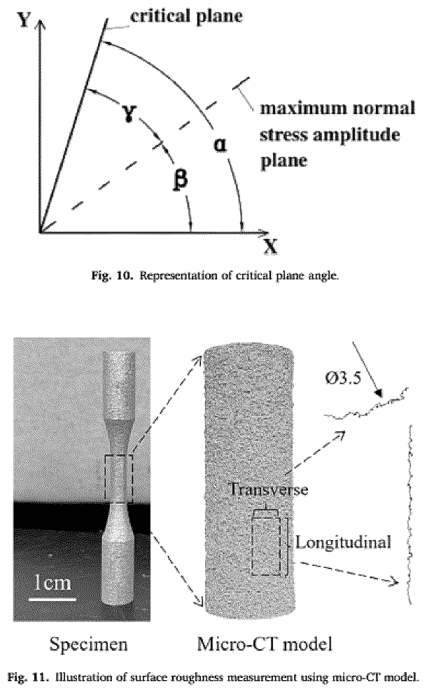

The parameter ‘y’ can be estimated from the expressions given in Table 1, and these angles are schematically shown in FIG. 10. The critical plane depends on the applied loading (i.e., the maximum normal stress amplitude plane) and the material properties (i.e., the angle between the critical plane and maximum normal stress amplitude plane). Once the threshold stress intensity factor criterion is developed, the methodology to predict the fatigue crack growth rate is straightforward. The threshold stress intensity factor is often related to the stress intensity at very low crack growth rates. Eq. (29) can be written as:

$$\frac{1}{Q} \sqrt{{( {k}_{1} )}^{2} + {( \frac{{k}_{2}}{s} )}^{2} + {P ( {k}^{H} )}^{2}} = {K}_{I , th} \qquad ( 34 )$$

For predictions corresponding to a general crack growth rate da/dN, the threshold stress intensity factors (K_{I,th} and K_{II,th}) may be replaced by the stress intensity coefficients at the specific crack growth rate (K_{I,da/dn} and K_{II,da/dn}). In one study the stress intensity coefficients at the specific crack growth rates are considered as equivalent stress intensity factor for the mixed-mode case. Hence, the mixed-mode crack growth model can be expressed as Eq. (35):

$${K}_{mixed , equivalent} = \frac{1}{Q} \sqrt{{( {k}_{1} )}^{2} + {( \frac{{k}_{2}}{s} )}^{2} + {P ( {k}^{H} )}^{2}} = {K}_{I , da / dn} \qquad ( 35 )$$

where ‘s’ is a parameter that is related to the material ductility and is expressed as the ratio of shear to normal fatigue limits.

$$s = \frac{{t}_{- 1}}{{f}_{- 1}} \qquad ( 36 )$$

Using Eq. (35), the multiaxial loading can be transformed into an equivalent uniaxial loading and directly estimate the fatigue life based on the time-based subcycle fatigue crack growth model.

### Computer-Implemented System

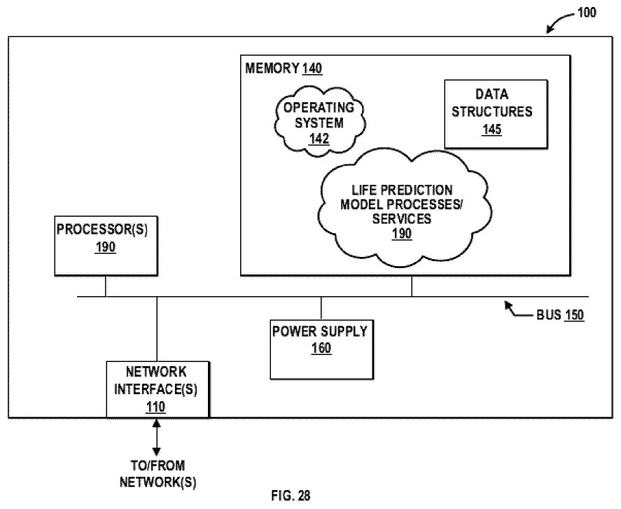

FIG. 28 is a schematic block diagram of an example device 100 that may be used with one or more embodiments described herein, e.g., as a component for a time-based fatigue life prediction model considering surface roughness of both conventional as well as additively manufactured parts.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Device 100 can also include a display device 130 that enables a user to view or otherwise interact with the aspects of the time-based fatigue life prediction model.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the system 100 and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include life prediction model processes/services 190, which can include aspects of the methods and/or implementations of various modules described herein. Note that while the life prediction model processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the life prediction model processes/services 190 is shown as a standalone process, those skilled in the art will appreciate that this process may be executed as a routine or module within other processes.

### 3. Model Validation

### 3.1 Experimental Data Under Uniaxial Loading

The experimental data presently disclosed involves additively manufactured Ti-6A1-4V specimens fabricated by laser-based powder bed fusion (L-PBF) method using EOS M290 (EOS GmbH) machine at the Carnegie Mellon University with a laser spot size of 100 μm. A total of 24 specimens were fabricated with a layer thickness of 30 μm and the infill process parameters are listed in Table 2. Before loading into the fatigue test setup, the gauge sections of all the specimens were scanned to measure the surface geometry using computed tomography (CT). The global porosity of all the specimens was less than 0.01% and considered to be less detrimental than global surface roughness. Thus, porosity was ignored.

To diagnose structural parts with inherent defects, micro computed tomography (micro-CT) has been widely used in the literature. It has great advantage in analyzing the surface roughness of non-planar structures and complex surface geometries, such as the overhanging features brought by the laser bed fusion process. This type of surface information is invisible to traditional surface roughness measurement techniques such as the optical profilometer systems. For the disclosed experiments, SkyScan 1272 X-ray micro-CT was used to scan the Ti64 specimens with a pixel size of 6.1 μm. To get the binarized sliced images, a global grayscale threshold of 100 was applied after denoising. A 3D model of the gauge section was then generated using the binarized image stack and the procedure for extracting the surface roughness information from the 3D cylinder models is illustrated in FIG. 11. It is worth noting that obtaining the effective notch root radius (ρ̅) from the micro-CT scans is relatively easy when compared to optical profilometry.

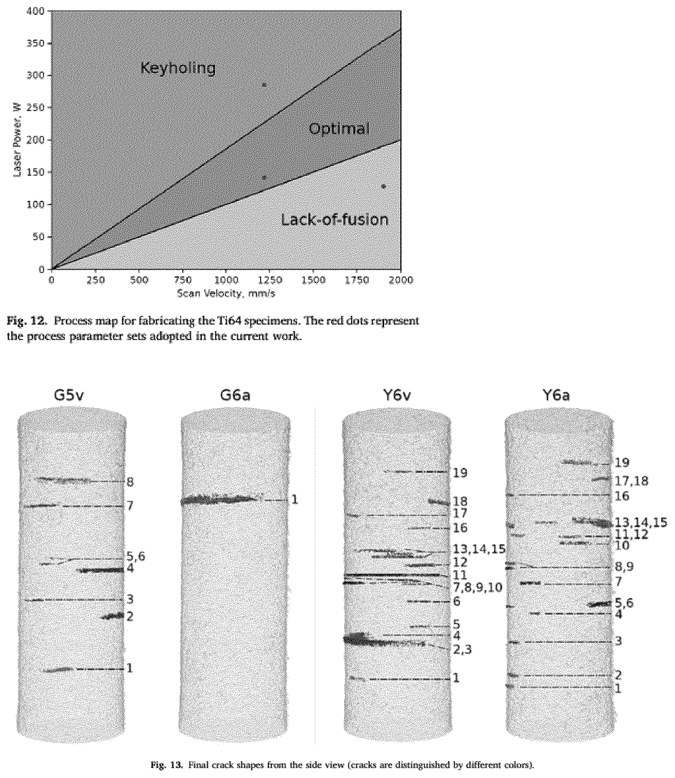

Previous research has discussed that regions in the process map represent distinct pore-forming mechanisms: inadequate melt pool overlap results in lack-of-fusion pores, and excess power density produces keyhole pores in the LB-PBF specimens. The process map for Ti64 alloy is shown in FIG. 12. The lack-of-fusion space corresponds to the suboptimal contour parameters shown in yellow and the optimal space corresponds to the optimal parameters whose area is shaded in green. Out of 24, twelve specimens were built in the optimal process space, denoted by ‘G’, and the remaining in the lack-of-fusion space, denoted by ‘Y’.

Additionally, for each category (G or Y), half of the specimens were built in vertical direction (v) and the remaining at 30 degrees from vertical (a). In the present disclosure, the specimens are named as (G/Y)-(build direction). For example, G-v and G-a specimens correspond to those built vertically and at an angle in the optimal space, respectively.

The specimens were tested for fatigue life as per ASTM E466-15 standard using a servo electro-hydraulic fatigue testing machine (MTS landmark 200 system) having a capacity of 100 kN. The stress ratio was maintained at 0.1 with a stress amplitude of 100 MPa and a loading frequency of 10 Hz. The cycle counts until complete fracture for all the specimens are tabulated in Table 5. It was observed that the specimens built in the optimal process space had fewer number of cracks as compared to those built in the lack-of-fusion space. The shapes of all the developed cracks from side view at the final fatigue loading cycle for four of the specimens are shown in FIG. 13. The crack surfaces are G-v perpendicular to the loading direction, which is true for uniaxial fatigue behavior.

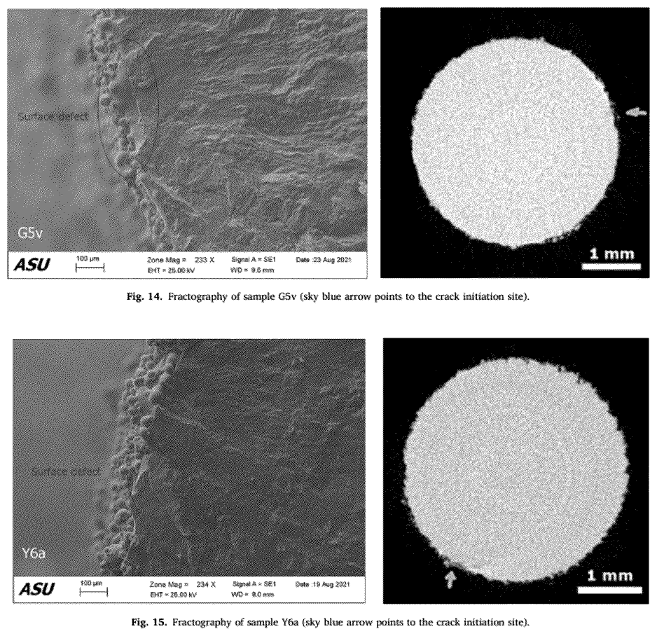

Multiple cracks were observed in the specimens as shown in FIG. 13. For example, a total of eight cracks were observed in the specimen G5v i.e., fifth specimen built vertically in the optimal process space. SEM and micro-CT cross-section images at the points of fatigue crack initiation for two specimens are shown in FIGS. 14 and 15.

These images show that the occurrence of the dominant cracks is associated with surface defects. Although some pores can be observed in the SEM images, their size is relatively very small and difficult to observe in the micro-CT cross-section images, indicating that they had limited influence on the fatigue life. The roughness data obtained from CT scans and the experimental fatigue data from in-house testing were used for validation of the proposed model. To demonstrate the roughness effect, the model initially needs to be validated for smooth specimens. For this purpose, fatigue life data for machined specimens was obtained from a previous study and assumed Kₜ=1.1 since most AM materials usually have negligible roughness in machined surface conditions with corresponding stress concentration factors close to 1. The material properties used for model calibration and the roughness parameters are given in Tables 3 and 4, respectively. It should be noted that the parameters A and B can be obtained from the Paris constants C and m given in Table 3.

TABLE 3
Mechanical properties of Ti—6Al—4V used for validation of in-house data.

| Material | σ_{y}(MPa) | σᵤ(MPa) | R | C | m | ΔKₜₕ(MPa - m^{0.5}) | Δσ_{f}(MPa) | a₀(μm) |
|---|---|---|---|---|---|---|---|---|
| Ti—6Al—4V | 951 | 1052 | 0.1 | 5.9E−13 | 3.1 | 1.15 | 230 | 7.96 |

TABLE 4
Surface roughness patterns for the in-house tested specimens.

| | Surface | | | | |
|---|---|---|---|---|---|
| Material | Condition | Rₐ(μm) | R_{y}(μm) | R_{z}(μm) | ρ̅(μm) |
| Ti—6Al—4V | G-v | 39.03 | 182.20 | 172.65 | 28.53 |
| | G-a | 30.17 | 172.89 | 163.90 | 30.19 |
| | Y-v | 51.16 | 232.03 | 223.11 | 32.23 |
| | Y-a | 34.78 | 202.90 | 193.86 | 34.07 |

TABLE 5
Experimental and predicted life values
for various specimens tested in-house.

| | Maximum Stress | Experimental | |
|---|---|---|---|
| Surface Condition | (MPa) | Cycles | Predicted Cycles |
| Machined | 450 | 333,802 | 581,969 |
| | 450 | 427,437 | 581,969 |
| | 450 | 879,166 | 581,969 |
| | 500 | 154,141 | 381,249 |
| | 500 | 193,354 | 381,249 |
| | 500 | 263,379 | 381,249 |
| | 600 | 56,743 | 189,381 |
| | 600 | 66,912 | 189,381 |
| | 600 | 83,073 | 189,381 |
| | 700 | 34,251 | 107,171 |
| | 700 | 47,627 | 107,171 |
| | 700 | 56,162 | 107,171 |
| G-v | 222 | 117,634 | 295,244 |
| | 222 | 250,466 | 295,244 |
| | 222 | 250,466 | 295,244 |
| | 200 | 225,800 | 428,901 |
| | 177 | 348,208 | 689,227 |
| | 155 | 749,316 | 1,218,569 |
| G-a | 222 | 151,395 | 478,764 |
| | 222 | 165,310 | 478,764 |
| | 200 | 387,569 | 707,541 |
| | 200 | 222,455 | 707,541 |
| | 177 | 529,868 | 1,169,842 |
| | 177 | 692,012 | 1,169,842 |
| Y-v | 222 | 110,387 | 194,734 |
| | 222 | 141,865 | 194,734 |
| | 177 | 311,142 | 441,389 |
| | 177 | 338,119 | 441,389 |
| | 155 | 535,646 | 757,746 |
| | 155 | 639,263 | 757,746 |
| Y-a | 222 | 115,532 | 405,024 |
| | 222 | 166,793 | 405,024 |
| | 177 | 423,875 | 972,533 |
| | 177 | 365,262 | 972,533 |
| | 155 | 462,977 | 1,771,049 |
| | 155 | 981,221 | 1,771,049 |

Scatter in the experimental data can be observed in Table 5. This could be due to a variety of reasons such as defect shape, material variability due to the fabrication parameters, and variability associated with mechanical testing among other factors. It should be noted that although only six representative specimens were fabricated for each category (G-v, G-a, Y-v, and Y-a), the variation in surface roughness across specimens was very small. Therefore, the values for the roughness parameters represent an average across all the specimens in each category.

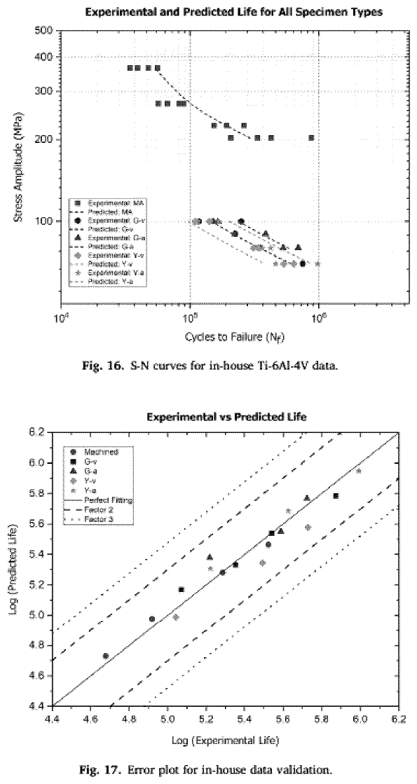

The model predictions were found to be very close to the experimental data FIG. 16, and this can be clearly seen in the error plot shown in FIG. 17 where the solid black line represents a perfect prediction. As seen, all the predictions are within a life factor of 2 which corresponds to 100% error.

TABLE 6
Mechanical properties of Ti—6Al—4V and 304L stainless steel used for model calibration.

| Material | σ_{y}(MPa | σᵤ(MPa) | R | C | m | ΔKₜₕ(MPa - m^{0.5}) | Δσ_{f}(MPa) | a₀(μm) |
|---|---|---|---|---|---|---|---|---|
| Ti—6Al—4V | 1003 | 1013 | −1 | 5.64E−13 | 3.3 | 1.15 | 450 | 2.08 |
| 304L | 208 | 420 | −1 | 2.89E−12 | 3.2 | 4 | 300 | 56.58 |
| Ti—6Al—4V | 951 | 1052 | −1 | 8.5E−12 | 3.3 | 0.9 | 150 | 11.46 |

TABLE 7
Surface roughness parameters for different specimens
under uniaxial loading (number in the bracket represents
standard deviation for the parameter).

| Material | Surface Condition | Rₐ(μm) | R_{y}(μm) | R_{z}(μm) | ρ̅(μm) |
|---|---|---|---|---|---|
| Ti—6Al—4V | M/P | 0.45 | 4.63 | 3.58 | NA |
| | | (0.26) | (1.40) | (1.17) | |
| | AB-1 | 22.65 | 126.92 | 75.23 | 23.77 |
| | | (5.41) | (30.10) | (18.20) | (11.06) |
| | AB-2 | 31.41 | 172.08 | 97.19 | 20.58 |
| | | (5.35) | (28.51) | (21.62) | (7.80) |
| 304L | AB | 12 (2) | 79 (13) | 63 (10) | 12 (4) |
| Ti—6Al—4V | MA | 0.12 | 1.1 | 0.92 | 0.45 |
| | AB | 15.45 | 110 | 92.2 | 17 |

TABLE 8
Experimental and predicted life for Ti—6Al—4V
data from Pegues et al..

| | Maximum Stress | Experimental | |
|---|---|---|---|
| Surface Condition | (MPa) | Cycles | Predicted Cycles |
| Machined | 525 | 560,000 | 515,063 |
| | 550 | 335,000 | 384,860 |
| | 630 | 140,000 | 180,235 |
| | 765 | 68,000 | 70,183 |
| As-built 1 | 215 | 330,000 | 199,380 |
| | 285 | 45,000 | 51,655 |
| | 325 | 64,000 | 29,346 |
| | 450 | 17,500 | 7927 |
| As-built 2 | 135 | 1,200,000 | 869,082 |
| | 225 | 46,000 | 53,778 |
| | 325 | 21,500 | 11,640 |
| | 340 | 16,500 | 9746 |
| | 485 | 7900 | 2521 |

TABLE 9
Experimental and predicted number reversals
for 304L stainless steel data.

| | Stress Amplitude | Experimental | Predicted |
|---|---|---|---|
| Surface Condition | (MPa) | Reversals | Reversals |
| Machined | 400 | 60,000 | 121,779 |
| | 380 | 250,000 | 176,296 |
| | 350 | 330,000 | 364,453 |
| As-built 1 | 380 | 10,000 | 33,064 |
| | 325 | 51,000 | 77,282 |
| | 300 | 140,000 | 129,123 |
| | 275 | 185,000 | 253,670 |
| | 250 | 300,000 | 736,659 |

TABLE 10
Experimental and predicted number of reversals
for Ti—6Al—4V data from Fatemi et al..

| | Stress Amplitude | Experimental | Predicted |
|---|---|---|---|
| Surface Condition | (MPa) | Reversals | Reversals |
| Machined | 350 | 87,246 | 39,496 |
| | 268 | 170,240 | 125,539 |
| | 205 | 246,796 | 486,123 |
| | 205 | 193,132 | 486,123 |
| As-built 1 | 332 | 20,780 | 9213 |
| | 223 | 53,990 | 44,639 |
| | 191 | 93,952 | 86,611 |
| | 191 | 36,668 | 86,611 |
| | 140 | 818,690 | 389,432 |

### 3.2 Literature Experimental Data Under Uniaxial Loading

In this section, the validation of the proposed model under uniaxial loading conditions is presented. The model is validated against experimental data for additively manufactured Ti-6A1-4V and 304L stainless steel collected from literature. The materials were fabricated based on laser-based powder bed fusion (L-PBF) method and tested under fully reversed loading condition (R=−1). The material properties used for model calibration and the surface roughness parameter values are tabulated in Tables 6 and 7, respectively. For the data from [78], the roughness parameters (except ρ̅) were estimated from the roughness profiles provided and ρ̅ was fitted to match with the experimental data.

Fatigue cracks initiated from the large roughness valleys for the as-built specimens in one study and from the surface in another. For the machined & polished specimens there were fewer crack initiation sites at the surface, but multiple cracks initiated from the internal lack-of-fusion defects. This highlights that surface roughness is highly concerning when dealing with specimens with rough surfaces. A prior study also found that in contrast to as-built specimens in which cracks usually initiate from surface defects, cracks initiate from internal or subsurface defects in machined specimens. The study concluded that apart from size, shape and density of pores, their location is also an important factor. It was observed that the defects closer to the surface had a greater detrimental effect on the fatigue life. As the fatigue crack initiation sites in these experimental works were at the surface, it is justified to validate the proposed model against them.

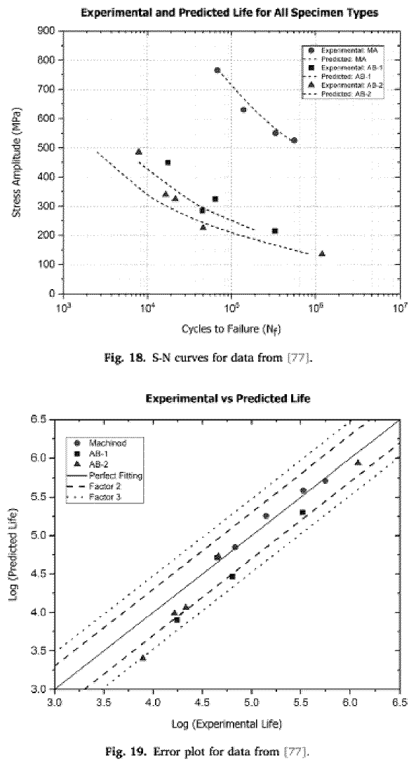

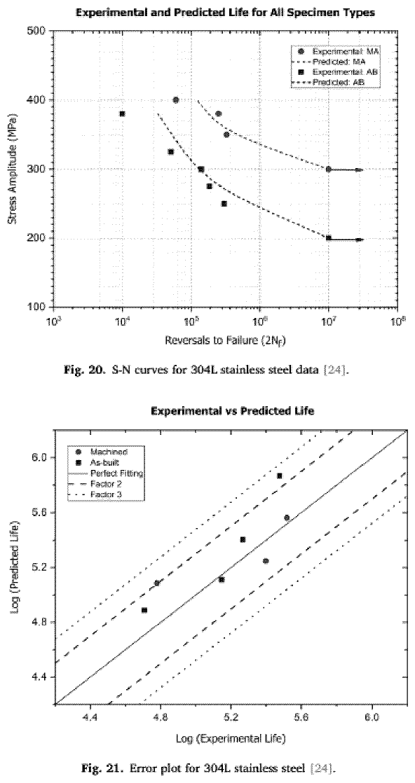

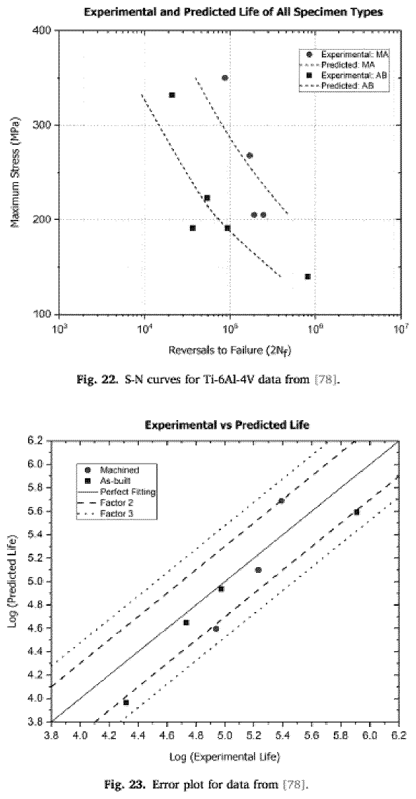

Fatigue life predictions for the data from the literature used were carried out and the results are tabulated in Tables 8, 9 and 10. The stress-life plots in FIGS. 18, 20 and 22 show the variation in fatigue life with roughness i.e., reduction in surface roughness leads to an increase in the fatigue life. As seen from the plots, the model predictions (represented by dashed lines) are close to the experimental data (represented by solid symbols). Error plots between the experimental and predicted fatigue life values with both the axes in log scale are shown in FIGS. 19, 21 and 23. The dashed and dotted lines represent factor 2 (100% error) and factor 3 (200% error), respectively, and are included for better interpretation of the results. Most of the predictions are within a factor of 2 and the remaining within factor 3, indicating that the proposed methodology is capable of predicting fatigue life of rough surface parts with good accuracy.

TABLE 11
Mechanical properties of Ti—6Al—4V under multiaxial loading.

| Material | σ_{y}(MPa | σᵤ(MPa) | R | C | m | ΔKₜₕ(MPa - m^{0.5}) | Δσ_{f}(MPa) | a₀(μm) |
|---|---|---|---|---|---|---|---|---|
| Ti—6Al—4V [78] | 951 | 1052 | −1 | 5.9E−12 | 3.3 | 1.2 | 230 | 8.66 |
| Ti—6Al—4V [45] | 1170 | 1250 | 0.05 | 5.9E−13 | 2.9 | 1.15 | 230 | 7.96 |

TABLE 12
Surface roughness parameters to Ti—6Al—4V
specimens under multiaxial loading.

| Material | Surface Condition | Rₐ(μm) | R_{y}(μm) | R_{z}(μm) | ρ̅(μm) |
|---|---|---|---|---|---|
| Ti—6Al—4V | Machined | 0.12 | 1.1 | 0.92 | 0.45 |
| [78] | AB | 15.45 | 110 | 92.2 | 17 |
| Ti—6Al—4V | Machined | 0.31 | 3 | 2.8 | 0.4 |
| [45] | As-built | 19.26 | 138.94 | 125 | 25 |

### 3.3 Literature Experimental Data Under Multiaxial Loading

In this section the validation of the proposed model under multiaxial loading condition is presented using experimental data for additively manufactured Ti-6A1-4V collected from literature. The data deals with two surface conditions, machined and as-built, tested at a stress ratio of

$$\frac{τ}{σ} = \frac{\sqrt{3}}{3}$$

in both the studies. The material properties used for model calibration are tabulated in Table 11. For the validation of data from the first study, the surface roughness parameter values were estimated from the roughness profiles provided and the parameter ‘ρ̅’ as fitted to match with the experimental data. To validate the data from the second study, the parameters R_{z}, and ρ̅ had to be fitted to match with the experimental data. The roughness parameters are listed in Table 12.

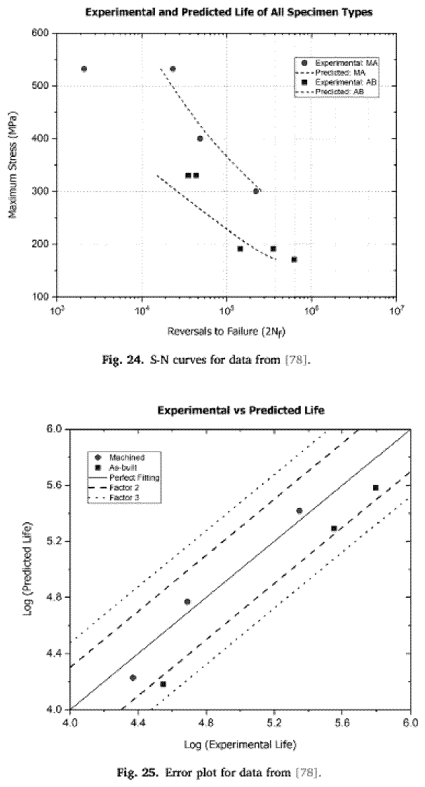

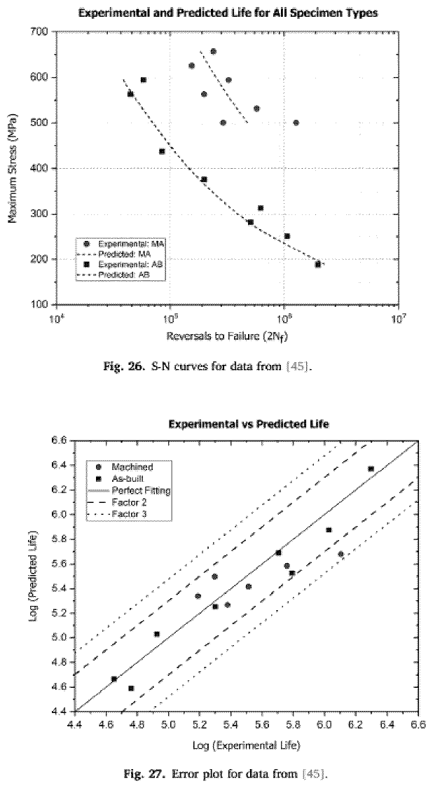

The fatigue life prediction results (FIGS. 24 and 26) for both of the multiaxial datasets along with the equivalent normal stresses calculated based on the critical plane approach described in the previous section are tabulated in Tables 13 and 14. The error plots in FIGS. 25 and 27 suggest that the model predictions are in good agreement with the experimental data and all the predictions are within a life factor of 3, which is considered good in the fatigue community.

### 4. Conclusions and Prospects

The objective of the work presently disclosed was to extend a previously developed time-based subcycle fatigue crack growth model to handle the effects of surface roughness on the fatigue life of additively manufactured parts. Modeling of surface roughness as a single equivalent notch with effective stress concentration estimated by Arola-Ramulu model has been achieved and the model is integrated with the concept of equivalent initial flaw size and an asymptotic interpolation method for the stress intensity factor solution for notches. The capability of the disclosed framework is validated against experimental data from in-house testing as well as open literature.

The validation dealt with additively manufactured Ti-6A1-4V and 304L stainless steel under uniaxial and multiaxial loading conditions. The variation of fatigue life with increasing surface roughness was successfully captured and most of the model predictions were found to be within an error factor range of 2, with some within a factor of 3, which are considered as good predictions for fatigue life.

Future work is needed to model the combined effect of surface roughness and internal porosity on the fatigue life of additively manufactured materials. Probabilistic fatigue life predictions are recommended for the reliability analysis of AM materials as they usually bring in considerable uncertainty concerning the material properties and manufacturing defects. Additional validation of the proposed model for a range of materials and surface conditions is proposed for future work to improve the robustness of the model.

TABLE 13
Experimental and predicted number of reversals
for Ti—6Al—4V data from Fatemi et al.

| | | Tensile | Shear | | Equivalent | | |
|---|---|---|---|---|---|---|---|
| Surface | Loading | Stress | Stress | | Uniaxial | Experimental | Predicted |
| Condition | Type | (MPa) | (MPa) | s | Stress (MPa) | Reversals | Reversals |
| Machined | In-Phase | 376 | 217 | 0.75 | 496 | 23,380 | 33,488 |
| | In-Phase | 283 | 163 | | 373 | 48,844 | 121,352 |
| | In-Phase | 213 | 122 | | 280 | 222,850 | 604,873 |
| As-Built | In-Phase | 234 | 135 | | 308 | 43,916 | 26,669 |
| | In-Phase | 135 | 78 | | 178 | 144,922 | 373,760 |
| | In-Phase* | 60 | 104 | | 159 | 626,392 | 768,229 |

TABLE 14
Experimental and predicted number of reversals for data from Renzo et al.

| | | Tensile | Shear | | Equivalent | | |
|---|---|---|---|---|---|---|---|
| Surface | Loading | Stress | Stress | | Uniaxial | Experimental | Predicted |
| Condition | Type | (MPa) | (MPa) | s | Stress (MPa) | Reversals | Reversals |
| Machined | In-Phase | 220 | 127 | 0.75 | 312 | 239,378 | 184,529 |
| | | 209 | 121 | | 297 | 154,888 | 218,106 |
| | | 199 | 115 | | 282 | 325,798 | 260,370 |
| | | 188 | 109 | | 267 | 198,130 | 313,949 |
| | | 178 | 103 | | 252 | 576,378 | 383,972 |
| | | 167 | 97 | | 238 | 291,936 | 476,030 |
| | | 167 | 97 | | 238 | 1,277,694 | 476,030 |
| As-Built | In-Phase | 199 | 115 | | 282 | 57,822 | 38,715 |
| | | 188 | 109 | | 267 | 44,966 | 46,224 |
| | | 146 | 84 | | 208 | 84,490 | 106,471 |
| | | 126 | 72 | | 178 | 199,154 | 178,715 |
| | | 105 | 60 | | 149 | 621,108 | 334,997 |
| | | 94 | 54 | | 134 | 509,144 | 487,236 |
| | | 84 | 48 | | 119 | 1,069,342 | 747,828 |
| | | 63 | 36 | | 89 | 1,985,452 | 2,344,795 |

What is claimed is:

1. A system for predicting fatigue life of an object comprising:
a processor in communication with a memory, the memory containing instructions executable by the processor to:
model a surface roughness of an object as an equivalent notch;
calculate an equivalent initial flaw size and an incremental crack length of the equivalent notch;
simulate a stress intensity factor for the equivalent notch; and
determine a fatigue life of the object with a time-based subcycle fatigue crack growth model, wherein the model uses the equivalent initial flaw size of the equivalent notch, incremental crack length of the equivalent notch, and the stress intensity factor;
wherein the determined fatigue life of the object predicts a number of stress load cycles that the object can undergo before fracturing.

2. The system of claim 1, wherein the object is a metallic object.

3. The system of claim 1, wherein the equivalent initial flaw size is either a long or a short crack length.

4. The system of claim 1, wherein the instructions are further executable by the processor to determine the fatigue life of the object with the time-based subcycle fatigue crack growth model using an average surface roughness of the object Rₐ as a depth of the equivalent notch d.

5. The system of claim 1, wherein the equivalent notch includes a notch root and a crack positioned at the notch root.

6. The system of claim 5, wherein the crack represents an effective stress concentration of all surface irregularities of the object.

7. The system of claim 1, wherein the object is manufactured using additive manufacturing.

8. The system of claim 1, wherein the object is subjected to a loading condition selected from any of uniaxial, multiaxial, constant, variable, or a combination thereof.

9. The system of claim 1, wherein the stress intensity factor of the equivalent notch is simulated by asymptotic interpolation.

10. The system of claim 1, wherein the time-based subcycle fatigue crack growth model further predicts the fatigue life of the object using a stress concentration factor due to surface roughness of the object.

11. A method of predicting fatigue life of an object manufactured by additive manufacturing comprising:
measuring an average surface roughness of an object having surface irregularities;
modeling the average surface roughness of the object as an equivalent notch;
calculating an equivalent initial flaw size and an incremental crack length of the equivalent notch;
simulating a stress intensity factor of the equivalent notch;
estimating a stress concentration factor of the surface irregularities of the object; and
determining a fatigue life of the object with a time-based subcycle fatigue crack growth model, wherein the model uses the equivalent initial flaw size of the equivalent notch, incremental crack length of the equivalent notch, and the stress intensity factor.

12. The method of claim 11, wherein the equivalent initial flaw size is either a long or a short crack length.

13. The method of claim 11, further comprising determining the fatigue life of the object with the time-based subcycle fatigue crack growth model using an average surface roughness of the object Rₐ as a depth of the equivalent notch d.

14. The method of claim 11, wherein the equivalent notch includes a notch root and a crack positioned at the notch root.

15. The method of claim 11, wherein the stress intensity factor of the equivalent notch is simulated by asymptotic interpolation.

16. A method of predicting fatigue life of an object comprising;
measuring an average surface roughness of an object having surface irregularities;
modeling the average surface roughness of the object as an equivalent notch from, the equivalent notch defining an equivalent initial flaw size and an incremental crack length;
simulating a stress intensity factor of the equivalent notch; and
determining a fatigue life of the object with a crack growth model, wherein the model uses the equivalent initial flaw size of the equivalent notch, incremental crack length of the equivalent notch, and the stress intensity factor.

17. The method of claim 16, wherein the crack growth model is a time-based subcycle fatigue crack growth model.

18. The method of claim 17, further comprising determining the fatigue life of the object with the time-based subcycle fatigue crack growth model using an average surface roughness of the object Rₐ as a depth of the equivalent notch d.

19. The method of claim 16, wherein the equivalent notch includes a notch root and a crack positioned at the notch root.

20. The method of claim 16, wherein the stress intensity factor of the equivalent notch is simulated by asymptotic interpolation.
